(19) United States
(12) Patent Application Publication
(10) Pub. No.: US 2024/0336782 A1
(43) Pub. Date: Oct. 10, 2024

(54) LIGHTWEIGHT COOL ROOF COATING COMPOSITIONS AND LIGHTWEIGHT COOL ROOF COATINGS

(71) Applicant: Covia Solutions Inc., Independence, OH (US)

(72) Inventors: SCOTT VANREMORTEL, Bakersville, NC (US); AN NGUYEN, Houston, TX (US)

(21) Appl. No.: 18/624,200

(22) Filed: Apr. 2, 2024

Related U.S. Application Data
(60) Provisional application No. 63/494,123, filed on Apr. 4, 2023.

(51) Int. Cl. C09D 5/33; C09D 7/40; C09D 7/61; C09D 7/80

(52) U.S. Cl. CPC C09D 5/004; C09D 7/61; C09D 7/69; C09D 7/80

(57) ABSTRACT

Disclosed herein are lightweight cool roof coating compositions and lightweight cool roof coatings. Also disclosed herein are lightweight reflective coating compositions, lightweight reflective coatings, and methods for making and applying the coating compositions of the present disclosure. The lightweight cool roof coating composition of the present disclosure comprises an aqueous polymer emulsion binder; and a pigment-filler component comprising: a reflective pigment, and a silica filler comprising cristobalite, tridymite, and optionally quartz, the silica filler comprising at least 50 wt % cristobalite based on the weight of the silica filler. The lightweight cool roof coating composition has a density (wet) of less than or equal to 1.38 g/cm³ at a Pigment Volume Concentration (PVC) of 42%.

### CROSS-REFERENCE TO RELATED APPLICATIONS

This application claims priority to and the benefit of U.S. Provisional Patent Application No. 63/494,123, filed Apr. 4, 2023, the entire content of which is incorporated by reference herein.

### BACKGROUND

Cool roof coatings, generally used on low slope and flat roofs, are designed to reflect incoming solar radiation and as a result reduce heat transfer into the underlying building. By reducing the cooling load needed for the building, the building can save on energy consumption and energy cost. The reflectivity of the roofing also increases the life of the roofing by reducing the rate of thermal degradation.

### SUMMARY

Disclosed herein are lightweight cool roof coating compositions and lightweight cool roof coatings. Also disclosed herein are lightweight reflective coating compositions, lightweight reflective coatings, and methods for making and applying the coating compositions of the present disclosure.

The lightweight cool roof coating composition of the present disclosure comprises an aqueous polymer emulsion binder; and a pigment-filler component comprising: a reflective pigment, and a silica filler comprising cristobalite, tridymite, and optionally quartz, the silica filler comprising at least 50 wt % cristobalite based on the weight of the silica filler. The lightweight cool roof coating composition has a density (wet) of less than or equal to 1.38 g/cm³ at a Pigment Volume Concentration (PVC) of 42%.

In aspects of the present disclosure, the silica filler comprises: 50-99 wt % cristobalite, 1-30 wt % tridymite, 0-50 wt % quartz, and 0-25 wt % amorphous silica.

In aspects of the present disclosure, the silica filler has: a L* of 97-99, an a* less than 0, and a b* of 0-0.75.

The present disclosure also provides a coated substrate comprising a structural substrate and the lightweight cool roof coating composition disposed thereon.

The present disclosure also provides a method of applying a cool roof to a structure comprising applying the lightweight cool roof coating composition to a roof of a structure.

A lightweight reflective coating composition of the present disclosure comprises a binder system comprising an aqueous acrylic emulsion binder, a (meth)acrylate-based binder system, a solvent-based resin system, a low-VOC solvent-based binder system, a two-component binder system, or a thermoplastic binder system and a pigment-filler component comprising: a reflective pigment and a silica filler comprising cristobalite, tridymite, and optionally quartz. The silica filler comprises at least 50 wt % cristobalite based on the weight of the silica filler, and the silica filler has: a L* of 97-99, an a* less than 0, and a b* of 0-0.75.

Other aspects of the present disclosure will be apparent from the description that follows.

### BRIEF DESCRIPTION OF THE DRAWINGS

FIG. 1 is a chart that shows the density (wet) of the aqueous coating composition vs. average total solar reflectance from the working examples.

FIG. 2 is a chart that shows the dry density of a coating formed from the coating composition vs. average total solar reflectance of the working examples.

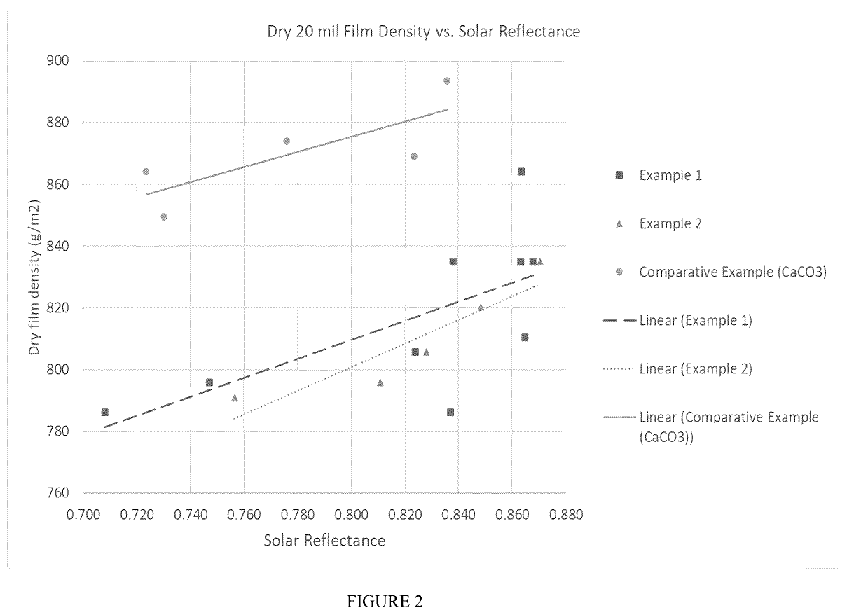

FIG. 3 is a chart that shows the average total solar reflectance vs. reflective pigment (TiO₂) loading of the coating compositions of the working examples.

### DETAILED DESCRIPTION

The present disclosure is directed to lightweight cool roof coating compositions, lightweight cool roof coatings, light weight reflective coating compositions, lightweight reflective coatings and methods for making and applying the coating compositions.

As discussed above, cool roof coatings are designed to reflect sunlight and heat away from a building, which can help to reduce cooling costs (reduce carbon footprint) and improve energy efficiency. Conventional cool roof coatings do this by using a reflective pigment such as titanium dioxide or zinc oxide in a white or almost white coating composition to reflect the sun's rays, rather than absorbing them. Because such coatings by their nature on roofs are exposed to the elements, typically the coating compositions contain a filler to help provide the desired rheological properties for workability of the coating composition and to yet apply the composition to the substrate at the desired thickness, as well as impart certain properties in the resulting coating that forms from the coating composition, such as durability and wear resistance. However, to avoid attenuating the white/reflective nature of the reflective pigment, ground calcium carbonate, natural ground feldspathic minerals, and kaolins, which are normally white or near white filler, are often used as fillers in conventional cool roof coatings. The lightweight cool roof coating compositions of the present disclosure improve upon these coating compositions by using a lighter (weight) filler than these conventional fillers, which results in a lighter (wet) coating composition and lighter (dry) coating than comparable coatings that contain the conventional fillers. For example, the lighter filler of the present disclosure has a specific gravity of 2.25-2.45, while the specific gravity of these conventional fillers may range from 2.61 (ground feldspathic minerals) to 2.7 (ground calcium carbonate, kaolins). The lighter filler of the lightweight cool roof coating compositions of the present disclosure are also a more reflective filler than calcium carbonate, which in turn permits the use of less reflective pigment such as titanium dioxide. The use of less titanium dioxide for the same reflective properties in the coating result in a further reduction in weight of the coating. The reduced weight, whether from the use of less filler and/or from the use of less reflective pigment, is beneficial for several reasons. Lighter material leads to lighter transport loads, which in turn lead to reduced transportation cost. The lighter material is also beneficial to the end user, as a lighter coating composition means lifting lighter five-gallon buckets of the liquid coating composition during application of the coating. The lighter and more reflective filler used in the lightweight coating compositions of the present disclosure is a silica filler described in more detail below.

### Lightweight Coating Composition

The lightweight cool roof coating compositions of the present disclosure comprise an aqueous polymer emulsion binder, a pigment-filler component, and optionally additives. The lightweight cool roof coating composition may further comprise additional water to adjust the solids content of the coating composition if the aqueous portion of the aqueous polymer emulsion binder does not include enough water. Up to 60 wt % water based on the weight of the lightweight cool roof coating compositions may be added in addition to any latent water present in other ingredients or components of the coating composition.

The lightweight cool roof coating compositions of the present disclosure may comprise from 40-80 wt % solids based on the weight of the lightweight cool roof coating composition, including 45-75 wt % solids, including 50-70 wt % solids, including 55-65 wt % solids. Alternatively, the lightweight cool roof coating compositions of the present disclosure may be defined by Pigment Volume Concentration (commonly referred to as PVC), which is represented by Vₚ/(Vₚ+V_{b})*100%, where Vₚ is the dry volume of the pigment-filler component and V_{b} is the dry volume of the aqueous polymer emulsion binder. In accordance with aspects of the present disclosure, the lightweight cool roof coating compositions have a PVC of 25-60%, including 35-55%, including 30-50%, including 35-45%, and including 40-45%.

The lightweight cool roof coating compositions of the present disclosure have a density (wet) of less than or equal to 1.38 g/cm³ at a Pigment Volume Concentration (PVC) of 42%, including less than or equal to 1.36 g/cm³, including less than or equal to 1.35 g/cm³, including less than or equal to 1.34 g/cm³, including from 1.25-1.38 g/cm³, including 1.28-1.38 g/cm³, including 1.30-1.38 g/cm³, including 1.32-1.38 g/cm³, including 1.34-1.38 g/cm³, including from 1.25-1.36 g/cm³, including 1.28-1.36 g/cm³, including 1.30-1.36 g/cm³, including 1.32-1.36 g/cm³, including 1.34-1.36 g/cm³, including from 1.25-1.35 g/cm³, including 1.28-1.35 g/cm³, including 1.30-1.35 g/cm³, and including 1.32-1.35 g/cm³, including from 1.25-1.34 g/cm³, including 1.28-1.34 g/cm³, including 1.30-1.34 g/cm³, and including 1.32-1.34 g/cm³ at a PVC of 42%.

### Aqueous Polymer Emulsion Binder

Any aqueous polymer emulsion binder suitable for use as a cool roof coating composition may be used in the lightweight cool roof coating compositions of the present disclosure. Such binders when dried or cured form waterproof, elastomeric roof coatings. Examples of such aqueous polymer emulsion binder compositions include emulsions based on acrylic, silicone, or polyurethane homopolymers or copolymers. As used herein, an “acrylic emulsion binder” refers to an acrylic homopolymer or copolymer aqueous emulsion binder. Likewise, a “silicone emulsion binder” refers to a silicone homopolymer or copolymer aqueous emulsion binder, and a “polyurethane emulsion binder” refers to a polyurethane homopolymer or copolymer aqueous emulsion binder. In certain aspects, the aqueous polymer emulsion binder of the present disclosure comprises an acrylic emulsion binder, a silicone emulsion binder, a polyurethane emulsion binder, and combinations thereof. Such emulsions may comprise from 30-70 wt % water based on the total weight of the aqueous polymer emulsion binder, including 40-60 wt % water, and including 45-55 wt % water based on the total weight of the aqueous polymer emulsion binder. An example of a suitable commercially available aqueous polymer emulsion binder is Acronal 4400 (available from BASF Corporation).

The aqueous polymer emulsion binder present in the lightweight cool roof coating compositions of the present disclosure ranges from 20-60 wt % based on the weight of the lightweight cool roof coating composition, including 25-55 wt %, including 30-50 wt %, and including 35-55 wt % based on the weight of the lightweight cool roof coating composition.

In accordance with certain aspect of the present disclosure, the refractive index of the aqueous polymer emulsion binder (when dried) is within 10% of the refractive index of the silica filler of the present disclosure, including within 7%, including within 6%, including within 5%, including within 4%, including within 3%, including within 2%, including within 1%. Without intending to be limited by any theory, it is believed that the if the respective refractive indices of the binder and silica filler are within 10% and lower, this assists the ability of the reflective pigment (e.g., titanium dioxide) present in the coating to reflect the solar radiation.

### Pigment-Filler Component

The lightweight cool roof coating compositions of the present disclosure comprise a pigment-filler component. The pigment-filler component comprises a reflective pigment and a silica filler. In accordance with aspects of the present disclosure, the pigment-filler component consists of the reflective pigment and silica filler.

### Reflective Pigment

The reflective pigment of the present disclosure includes pigments that reflect solar radiation away from the roof. Examples of suitable reflective pigments include titanium dioxide, zinc oxide, zirconium oxide, barium sulfate, titanium calcium, antimony oxide, zinc sulfide, and combinations thereof. The titanium dioxide may be rutile and/or anatase. A preferred reflective pigment is titanium dioxide. In certain aspect of the present disclosure, the reflective pigment present in the lightweight cool roof coating compositions consists of titanium dioxide.

Those skilled in the art would be able to select suitable particle sizes of the various reflective pigments for the lightweight cool roof coating of the present disclosure. For example, suitable average median particle size for titanium dioxide range from 0.05-3 μm, including from 0.1-2 μm, including 0.2-1 μm.

The reflective pigment present in the lightweight cool roof coating compositions of the present disclosure ranges from 1-15 wt % based on the weight of the lightweight cool roof coating composition, including 5-12 wt %, including 5-10 wt %, including 5-9 wt %, including 5-8 wt %, and including 5-7 wt % based on the weight of the lightweight cool roof coating composition. In certain aspects, the reflective pigment comprises titanium dioxide, and the titanium dioxide present in the lightweight cool roof coating compositions of the present disclosure ranges from 1-15 wt % based on the weight of the lightweight cool roof coating composition, including 5-12 wt %, including 5-10 wt %, including 5-9 wt %, including 5-8 wt %, and including 5-7 wt % based on the weight of the lightweight cool roof coating composition.

### Silica Filler

As discussed above, the lightweight coating compositions of the present disclosure comprise a silica filler. The silica filler comprises cristobalite, tridymite, and optionally quartz. Cristobalite comprises the majority (by weight) of the silica filler, as cristobalite comprises at least 50 wt % of the silica filler based on the weight of the silica filler, including at least 55 wt %, including at least 60 wt %, including at least 65 wt %, including at least 70 wt %, including at least 75 wt %, including at least 80 wt %, including at least 81 wt %, including 50-99 wt %, including 50-95 wt %, including 50-91 wt %, including 55-99 wt %, including 55-95 wt %, including 55-91 wt %, including 60-99 wt %, including 60-95 wt %, including 60-91 wt %, including 65-99 wt %, including 65-95 wt %, including 65-91 wt %, including 70-99 wt %, including 70-95 wt %, including 70-91 wt %, including 75-99 wt %, including 75-95 wt %, including 75-91 wt %, including 80-99 wt %, including 80-95 wt %, including 80-91 wt %, including 81-99 wt %, including 81-95 wt %, and including 81-91 wt % based on the weight of the silica filler.

The silica filler also comprises tridymite. The silica filler comprises at least 1 wt % tridymite based on the weight of the silica filler, including at least 5 wt %, including at least 9 wt %, including at least 11 wt %, including at least 15 wt %, including at least 20 wt %, including at least 25 wt %, including 1-30 wt %, including 5-30 wt %, including 9-30 wt %, including 11-30 wt %, including 15-30 wt %, including 20-30 wt %, including 25-30 wt %, including 1-27 wt %, including 5-27 wt %, including 9-27 wt %, including 11-27 wt %, including 15-27 wt %, including 20-27 wt %, including 25-27 wt %, including 1-25 wt %, including 5-25 wt %, including 9-25 wt %, including 11-25 wt %, including 15-25 wt %, including 20-25 wt %, including 1-20 wt %, including 5-20 wt %, including 9-20 wt %, including 11-20 wt %, including 15-20 wt %, including 1-15 wt %, including 5-15 wt %, including 9-15 wt %, and including 11-15 wt % based on the weight of the silica filler.

The silica filler may optionally comprise quartz. Thus, the amount of quartz in the silica filler may range from 0-50 wt % based on the weight of the silica filler, including at least 1 wt % quartz based on the weight of the silica filler, including at least 5 wt %, including at least 10 wt %, including at least 15 wt %, including at least 20 wt %, including at least 25 wt %, including at least 30 wt %, including at least 35 wt %, including at least 40 wt %, including 1-40 wt %, including 5-40 wt %, including 10-40 wt %, including 15-40 wt %, including 20-40 wt %, including 25-40 wt %, including 30-40 wt %, including 35-40 wt %, including 1-35 wt %, including 5-35 wt %, including 10-35 wt %, including 15-35 wt %, including 20-35 wt %, including 25-35 wt %, including 30-35 wt %, including 1-30 wt %, including 5-30 wt %, including 10-30 wt %, including 15-30 wt %, including 20-30 wt %, including 25-30 wt %, including 1-25 wt %, including 5-25 wt %, including 10-25 wt %, including 15-25 wt %, including 20-25 wt %, including 1-20 wt %, including 5-20 wt %, including 10-20 wt %, including 15-20 wt %, including 1-15 wt %, including 5-15 wt %, including 10-15 wt %, including 1-10 wt %, including 5-10 wt %, and including 1-5 wt % based on the weight of the silica filler.

Amorphous silica may optionally be present at less than or equal to 25 wt % based on the weight of the silica filler, including 0-25 wt %, including less than 22.5 wt %, including less than 20 wt %, including less than 17 wt %, including less than 14 wt %, including less than 11 wt %, including less than 9 wt %, including less than 5 wt %, including less than 3 wt %, including less than 1 wt %, and including no amorphous silica.

The silica filler, as understood herein, refers to a filler comprising at least 90 wt % silica, based on the total weight of the silica filler, including 95 wt % silica, including 97% silica, including 98 wt % silica, including 99 wt % silica, including 99.5 wt % silica, including 99.9 wt % silica, and including 100 wt % silica based on the total weight of the silica filler. Preferably, the silica filler has at least 99.5 wt % silica based on the total weight of the silica filler. Conversely, the silica filler has less than 10 wt % impurities, including less than 5 wt %, including less than 3 wt %, including less than 2 wt %, including less than 1 wt %, including less than 0.5 wt %, including less than 0.01 wt %, and including no impurities based on the total weight of the silica filler.

The silica filler present in the lightweight cool roof coating compositions of the present disclosure ranges from 20-45 wt % based on the weight of the lightweight cool roof coating composition, including 22-42 wt %, including 25-40 wt %, including 25-35 wt %, including 25-30 wt %, including 30-40 wt %, including 35-40 wt %, and including 35-40 wt % based on the weight of the lightweight cool roof coating composition.

The silica filler of the present disclosure has a d50 (median) particle size of 1-25 μm, including d(50) particle size ranging from 1-20 μm, including 1-15 μm, including 1-12 μm, including 1-10 μm, including 1-8 μm, including 1-5 μm, 1-25 μm, including 2-20 μm, including 2-15 μm, including 2-12 μm, including 2-10 μm, including 2-8 μm, including 2-5 μm, including 3-20 μm, including 3-15 μm, including 3-12 μm, including 3-10 μm, including 3-8 μm, and including 3-5 μm. The silica filler of the present disclosure may have a d99 (top size) particle size of 75 μm, including 70 μm, including 65 μm, including 60 μm, including 55 μm, including 55 μm, including 50 μm, including 45 μm, including 40 μm, including 35 μm, including 30 μm, and including 25 μm. Note, any d99 particle size disclosed herein for the silica filler may be combined with any d50 particle size range disclosed herein for the silica filler. Unless otherwise indicated here, particle size is determined by laser diffraction detailed in the working examples.

The silica filler of the present disclosure has a specific gravity (ratio of density of substance to density of water at 4° C.) ranging from 2.25-2.45, including 2.28-2.45, including 2.30-2.45, including 2.32-2.45, including 2.35-2.45, including 2.38-2.45, including 2.40-2.45, including 2.42-2.45, including 2.28-2.42, including 2.30-2.42, including 2.32-2.42, including 2.35-2.42, including 2.38-2.42, including 2.40-2.42, including 2.28-2.40, including 2.30-2.40, including 2.32-2.40, including 2.35-2.40, including 2.38-2.40, including 2.28-2.38, including 2.30-2.38, including 2.32-2.38, including 2.35-2.38, including 2.28-2.36, including 2.30-2.36, including 2.32-2.36, including 2.35-2.36, including 2.28-2.34, including 2.30-2.34, and including 2.32-2.34.

Due at least in part to the majority cristobalite in the silica filler, the silica filler of the present disclosure has particularly white color characteristics. With a d50 particle size of 1-25 and a d99 particle of 75, the silica filler of the present disclosure exhibits a L* value in the CIELAB color space of at least 97, including at least 98, including at least 98.5, including at least 99, including at least 99.5, including up to 99.75, including up to 99.9, including up to 100, including 97-100, including 98-100, including 98.5-100, including 99-100, including 99.5-100, including 97-99.9, including 98-99.9, including 98.5-99.9, including 99-99.9, including 99.5-99.9, including 97-99.75, including 98-99.75, including 98.5-99.75, including 99-99.75, including 99.5-99.75, including 97-99.5, including 98-99.5, including 98.5-99.5, including 99-99.5, including 97-99, including 98-99, including 98.5-99, including 97-98.5, including 98-98.5, and including 97-98.

With a d50 particle size of 1-25 and a d99 particle of 75, the silica filler of the present disclosure exhibits an a* value in the CIELAB color space of less than or equal to 0, including less than 0, including −0.5 to 0, including −0.5 to −0.001, including −0.5 to −0.01, including −0.5 to −0.02, including −0.5 to −0.05, including −0.5 to −0.1, including −0.5 to −0.15, including −0.5 to −0.2, including −0.5 to −0.25, including −0.5 to −0.3, including −0.5 to −0.35, including −0.5 to −0.4, including −0.5 to −0.45, including −0.4 to −0.001, including −0.4 to −0.01, including −0.4 to −0.02, including −0.4 to −0.05, including −0.4 to −0.1, including −0.4 to −0.15, including −0.4 to −0.2, including −0.4 to −0.25, including −0.4 to −0.3, including −0.4 to −0.35, including −0.3 to −0.001, including −0.3 to −0.01, including −0.3 to −0.02, including −0.3 to −0.05, including −0.3 to −0.1, including −0.3 to −0.15, including −0.3 to −0.2, including −0.3 to −0.25, including −0.25 to −0.001, including −0.25 to −0.01, including −0.25 to −0.02, including −0.25 to −0.05, including −0.25 to −0.1, including −0.25 to −0.15, including −0.25 to −0.2, including −0.2 to −0.001, including −0.2 to −0.01, including −0.2 to −0.02, including −0.2 to −0.05, including −0.2 to −0.1, including −0.2 to −0.15, including −0.16 to −0.001, including −0.16 to −0.01, including −0.16 to −0.02, including −0.16 to −0.05, including −0.16 to −0.1, including −0.12 to −0.001, including −0.12 to −0.01, including −0.12 to −0.02, including −0.12 to −0.05, and including −0.12 to −0.1.

With a d50 particle size of 1-25 and a d99 particle of 75, the silica filler of the present disclosure exhibits a b* value in the CIELAB color space of up to 2, including up to 1.75, including 1.5, including 1.25, including 1, including up to 0.75, including up to 0.55, including up to 0.5, including 0-2, including 0-1.75, including 0-1.5, including 0-1.25, including 0-1, including 0-0.75, including 0-0.55, including 0-0.5, including 0.05-2, including 0.05-1.75, including 0.05-1.5, including 0.05-1.25, including 0.05-1, including 0.05-0.75, including 0.05-0.55, including 0.05-0.5, including 0.1-2, including 0.1-1.75, including 0.1-1.5, including 0.1-1.25, including 0.1-1, including 0.1-0.75, including 0.1-0.55, including 0.1-0.5, including 0.15-2, including 0.15-1.75, including 0.15-1.5, including 0.15-1.25, including 0.15-1, including 0.15-0.75, including 0.15-0.55, including 0.15-0.5, including 0.2-2, including 0.2-1.75, including 0.2-1.5, including 0.2-1.25, including 0.2-1, including 0.2-0.75, including 0.2-0.55, including 0.2-0.5, including 0.25-2, including 0.25-1.75, including 0.25-1.5, including 0.25-1.25, including 0.25-1, including 0.25-0.75, including 0.25-0.55, including 0.25-0.5, including 0.3-2, including 0.3-1.75, including 0.3-1.5, including 0.3-1.25, including 0.3-1, including 0.3-0.75, including 0.3-0.55, including 0.3-0.5, including 0.35-2, including 0.35-1.75, including 0.35-1.5, including 0.35-1.25, including 0.35-1, including 0.35-0.75, including 0.35-0.55, including 0.35-0.5, including 0.4-2, including 0.4-1.75, including 0.4-1.5, including 0.4-1.25, including 0.4-1, including 0.4-0.75, including 0.4-0.55, including 0.4-0.5, including 0.45-2, including 0.45-1.75, including 0.45-1.5, including 0.45-1.25, including 0.45-1, including 0.45-0.75, including 0.45-0.55, and including 0.45-0.5.

Unless otherwise indicated herein, the L*, a*, and b* values are measured using an X-rite 9600 reflective spectrophotometer using a 25 mm diameter optical glass cuvette.

The silica filler of the present disclosure may be made in accordance with making the powder in International Patent Application Serial No.: PCT/US2023/72546, filed Aug. 21, 2023 entitled “REFLECTIVE SILICA BASED GRANULES AND POWDER FOR USE IN ROOFING AND ARCHITECTURAL MATERIALS AND PROCESSES FOR MAKING THE SAME” which has been incorporated by reference herein.

### Optional Additives

The lightweight cool roof coating composition may further comprise conventional additives such as preservatives, antimicrobial agents, mildewcides, antifreeze agents such as polyethylene glycol, coalescents, dispersants, defoaming agents, colorants, dyes, cosolvents, plasticizers, UV stabilizers, flame retardants, thickeners, rheology agents, and adhesion promoters. The optional additives may be present in the lightweight cool roof coating compositions of the present disclosure ranging from 0-10 wt % based on the weight of the lightweight cool roof coating composition, including 1-8 wt %, including 1-5 wt %, including 2-8 wt %, and including 2-5 wt % based on the weight of the lightweight cool roof coating composition.

### Method of Making and Using

The present disclosure also includes methods of making the lightweight cool roof coating composition. These methods include hydrating the pigment-filler component and combining that component with the aqueous polymer dispersion. The step of hydrating the pigment-filler component includes combining the reflective pigment and silica filler with water and at least one of mixing or dispersing to form a mixture. This mixing or dispersing can be done at high shear, for example, on a Cowles disperser. At this point, optional additives to assist the hydration may be added, including but not limited to dispersants, preservatives, antifreeze agents, and defoaming agents. This mixture is mixed for an adequate period of time to permit uniform mixing, uniform dispersion, and/or adequately hydration of the all of the pigment-filler component. Then the aqueous polymer emulsion binder is added and mixed to form the lightweight cool roof coating composition. Typically, the mixing used when adding the aqueous polymer emulsion binder is not at high shear, as high shear mixing at this point can damage the polymer and/or lead to instability of the coating. Other optional additives may also be added along with the binder in this step, including but not limited to cosolvents, coalescents, rheology agents, antifreeze agents, and any other desired additives. The lightweight cool roof coating composition may then be let down for a period of time before applying to a substrate as a coating.

The present disclosure also includes methods of using the lightweight cool roof coating composition. As an aqueous emulsion coating composition, the lightweight cool roof coating composition may simply be applied directly to the substrate, e.g., a roof, and dried (e.g., the aqueous and any cosolvents in the mixture evaporate off). Depending on the type of aqueous polymer emulsion binder used, cross-linking and/or curing may also take place as the coating composition dries. Because the substrate may be a roof or other architectural structure that may need waterproofing, the lightweight cool roof coating composition may be applied by brushing, rolling, flowing, spraying, and any other suitable means for applying a roofing coating. The coating composition may be applied in one or more coats in a manner, which when applied, forms the lightweight cool roof coating at a thickness (wet) ranging from 5-300 mils, including 10-150 mils, including 10-125 mils, including 15-125 mils, including 15-100 mils, including 15-90 mils, including 15-80 mils, including 15-70 mils, including 15-60 mils, including 15-50 mils, including 15-40 mils, including 15-30 mils, including 20-125 mils, including 20-100 mils, including 20-90 mils, including 20-80 mils, including 20-70 mils, including 20-60 mils, including 20-50 mils, including 20-40 mils, and including 20-30 mils. When dried, the lightweight cool roof coating has a thickness (dry) ranging from 5-295 mils, including 10-150 mils, including 10-125 mils, including 10-100 mils, including 10-90 mils, including 10-80 mils, including 10-70 mils, including 10-60 mils, including 10-50 mils, including 10-40 mils, including 10-30 mils, including 10-20 mils, including 15-125 mils, including 15-100 mils, including 15-90 mils, including 15-80 mils, including 15-70 mils, including 15-60 mils, including 15-50 mils, including 15-40 mils, including 15-30 mils, including 20-125 mils, including 20-100 mils, including 20-90 mils, including 20-80 mils, including 20-70 mils, including 20-60 mils, including 20-50 mils, including 20-40 mils, and including 20-30 mils. One or more coating layers may be applied to the substrate to form the cool roof coating. It should be noted that the added thickness (e.g., from multiple coating layers) does not detract from the advantageous properties of the coatings of the present disclosure. Although not necessary, if desired, a primer or other form of adhesion promoter and/or sealer may be applied to the substrate prior to the application of the lightweight cool roof coating composition.

### Substrates

The lightweight cool roof coating compositions of the present disclosure is applied to a substrate, such as a roof or other architectural or structural member such as walls, trims, patio, decking, etc. that can benefit from waterproofing under exposure to the elements. Preferably the substrate is a low-slope or flat roof. Nonlimiting examples of suitable substrate materials include, urethane foam, polymer membrane, thermal plastic polyolefin, fiber-reinforced material (e.g., fiberglass reinforced), fiber-reinforced woven material (e.g., fiberglass reinforced), wood, asphalt, asphalt shingles, built-up roofs, bituminous coatings, metal, plaster, stucco, and cement. In other aspects, the substrate is a component of a manufactured cool roof building material. For example, the substrate may comprise a flexible material such as felt, bituminous mat, fiberglass, polyester, and a woven fabric in which the cool roof coating is applied to the substrate in a manufacturing environment rather than application in the field on the roof.

### Cool Roof Coating Properties

The cool roof coatings formed from the lightweight cool roof coating compositions of the present disclosure are lightweight. As such, when applied at 20 mils (wet) thickness (dried at about 10 mils thickness), the lightweight cool roof coating has a surface density (dry) of less than 865 g/cm², including less than 860 g/cm², including less than 855 g/cm², including less than 850 g/cm², including less than 845 g/cm², including less than 840 g/cm², including from 780-865 g/cm², including from 790-865 g/cm², including from 800-865 g/cm², including from 810-865 g/cm², including from 820-865 g/cm², including from 830-865 g/cm², including from 840-865 g/cm², including from 850-865 g/cm², including from 855-865 g/cm², including from 780-850 g/cm², including from 790-850 g/cm², including from 800-850 g/cm², including from 810-850 g/cm², including from 820-850 g/cm², including from 830-850 g/cm², including from 840-850 g/cm², including from 780-835 g/cm², including from 790-835 g/cm², including from 800-835 g/cm², including from 810-835 g/cm², including from 820-835 g/cm², including from 830-835 g/cm², including from 780-825 g/cm², including from 790-825 g/cm², including from 800-825 g/cm², including from 810-825 g/cm², and including from 820-825 g/cm² when applied at 20 mils (wet) thickness (dried at about 10 mils thickness).

The lightweight cool roof coatings of the present disclosure, when applied at 20 mils (wet) thickness (dried at about 10 mils thickness) on a substrate, exhibits a L* value in the CIELAB color space of at least 95, including at least 96, including at least 97, including at least 97.5, including at least 98, including at least 98.5, including at least 99, including up to 99.5, including 95-99, including 96-99, including 97-99, including 97.5-99, including 98-99, and including 98.5-99.

With an L* value in the CIELAB color space of at least 95, the lightweight cool roof coatings, when applied at 20 mils (wet) thickness (dried at about 10 mils thickness) on a substrate, have an average solar reflectance of at least 0.75, and conversely an average solar absorbance of less that 0.25. With an L* value in the CIELAB color space of at least 96, including 97-99, the lightweight cool roof coatings, when applied at 20 mils (wet) thickness (dried at about 10 mils thickness) on a substrate, have an average solar reflectance of at least 0.80, including 0.80-0.90, including 0.82-0.90, including 0.84-0.90, including 0.86-0.90, including 0.80-0.88, including 0.82-0.88, including 0.84-0.88, including 0.86-0.88, including 0.80-0.86, including 0.82-0.86, including 0.84-0.86; and conversely an average solar absorbance of less than 0.20, including 0.10-0.20, including 0.10-0.18, including 0.10-0.16, including 0.10-0.14, including, 0.12-0.20, including 0.12-0.18, including 0.12-0.16, including, 0.12-0.14, including 0.14-0.20, including 0.14-0.18, and including 0.14-0.16.

### Further Applications

In accordance with certain aspects, the present disclosure is also directed to lightweight reflective coating compositions and the coatings formed therefrom suitable for other applications, including but not limited to reflective road paint, reflective sign paint, and the like. The lightweight reflective coating compositions may be the same as the lightweight cool roof coating compositions disclosed herein or modified versions of those lightweight cool roof coating compositions to make them more suitable for their intended purpose. Such coatings include the silica-based filler in accordance with the present disclosure, including in amounts disclosed in accordance with the present disclosure.

If used as a lightweight reflective coating for road surface markings, the aqueous polymer emulsion binder of the lightweight reflective coating composition can be modified or completely replaced with a different binder system to improve its adhesion and durability for application to road surfaces such as asphalt, cement, or brick or for applications to road signs having metal or wood surfaces. For example, lightweight reflective coating compositions may include an acrylic latex binder, which may be the same or different than the aqueous acrylic emulsion binders disclosed herein, or a (meth)acrylate-based binder system, a solvent-based resin binder system such as hydrocarbon-based (oil-based) resins or alkyd-based (e.g., polyester resin modified by fatty acids) resins, low VOC solvent (e.g., acetone)-based binder systems, as well as two-component binder systems such as two-part polyurethane or two-part epoxy-based systems in place of the aqueous polymer emulsion binder. In some instances, the binder is a thermoplastic polymer and requires heating to its softened/malleable form to apply it to the desired substrate, e.g., road surface or sign. In accordance with aspects of the present disclosure, the lightweight reflective coating composition comprises a binder system comprising an aqueous acrylic emulsion binder, a (meth)acrylate-based binder system, a solvent-based resin binder system, a low-VOC solvent-based binder systems, a two-component binder system, or a thermoplastic binder system.

The reflective paints of the present disclosure may also include the reflective pigments disclosed herein and/or additional pigments so that the resulting coating is a color other than white (e.g., yellow).

The lightweight reflective coating compositions of the present disclosure may also contain additional additives or components to enhance its reflective properties. For example, reflective coatings often contain glass beads to enhance the reflectiveness of the coatings. Although they can be mixed in when preparing the lightweight reflective coating composition, the glass beads may be applied to the wet coating (e.g., sprinkled on or embedded in) after its application to the substrate. It should be understood that the silica filler may also be used as a substitute for at least a portion of the glass beads or other mineral fillers in such reflective coatings.

The lightweight reflective coating compositions of the present disclosure also have a density (wet) the similar or the same as the lightweight cool roof coating compositions disclosed herein. The lightweight reflective coating compositions may have a density of less than or equal to 1.38 g/cm³ at a Pigment Volume Concentration (PVC) of 42%, including less than or equal to 1.36 g/cm³, including less than or equal to 1.35 g/cm³, including less than or equal to 1.34 g/cm³, including from 1.25-1.38 g/cm³, including 1.28-1.38 g/cm³, including 1.30-1.38 g/cm³, including 1.32-1.38 g/cm³, including 1.34-1.38 g/cm³, including from 1.25-1.36 g/cm³, including 1.28-1.36 g/cm³, including 1.30-1.36 g/cm³, including 1.32-1.36 g/cm³, including 1.34-1.36 g/cm³, including from 1.25-1.35 g/cm³, including 1.28-1.35 g/cm³, including 1.30-1.35 g/cm³, and including 1.32-1.35 g/cm³, including from 1.25-1.34 g/cm³, including 1.28-1.34 g/cm³, including 1.30-1.34 g/cm³, and including 1.32-1.34 g/cm³ at a PVC of 42%.

Other properties disclosed herein for the lightweight cool roof coating compositions apply equally to the lightweight reflective coating compositions disclosed herein, unless otherwise indicated or compositional differences necessitate otherwise. The methods of making and the methods of applying the lightweight cool roof coating compositions of the present disclosure are also equally applicable to the lightweight reflective coating compositions disclosed herein, unless otherwise indicated or differences (e.g., 2 component vs. 1 component) necessitate otherwise.

### EXAMPLES

The following examples are included for the purposes of illustration and do not limit the general inventive concepts described herein.

Cool roof coating compositions (Examples 1 and 2) using the silica filler in accordance with the present invention as the “Mineral Filler” are made by adding the ingredients of Component A in Table 1 to a 2000 mL stainless steel Griffin beaker, and using an overhead mixer with a CM-100 Lab Disperser blade, mixing (dispersing) Component A for 10-15 minutes. Note, the amounts of titanium dioxide and Mineral Filler used with the composition of Table 1 are varied using the amounts shown in Table 2 while maintaining a PVC of 42% for the coating compositions (the same titanium dioxide and Mineral Filler amounts while maintaining a PVC of 42% are shown in Table 3 for convenience). Prior to adding the Mineral Filler, the particle size of the Mineral Filler is measured via laser diffraction (Beckman Coulter LS 13 320), the specific gravity is measured via helium pycnometry (Micromeritics Accupyc II 1340), and the L*, a*, and b* are measured using an X-rite 9600 reflective spectrophotometer using a 25 mm diameter optical glass cuvette. These measurements are shown in Table 4 below. After the grinding is complete, the mixer blade is changed to a IKA RW20 paddle mixing blade and then the ingredients of Component B are added while mixing. After adding all components and mixing, the cool roof coating composition is let down for about 10 minutes. A comparative cool roof coating composition is made in the same manner, except calcium carbonate (HIFILL 10) as the Mineral Filler instead of the inventive silica filler (loading amounts of calcium carbonate shown in Table 2 and identically in Table 3).

After the let down, the viscosity, pH, and density of liquid coating compositions are measured and the results are provided in Table 2. The viscosity is measured using a using a BYK byko-visc DS Stormer viscometer 8324. The pH is measured using an Extech Exstik pH meter. The density is measured using a density cup (filled cup with liquid coating composition to specified volume, record weight and then determine density).

The coating was applied onto a sealed black and white BYK Gardner opacity test chart (model #2811) using a 20 mil BYK drawdown bar on a polished stainless steel drawdown vacuum plate to obtain a 20 mil wet thickness cool roof coating (which dried to about a 10 mil thick coating). The coating compositions are then allowed to dry at ambient conditions (room temperature), and then the L* and contrast ratio are measured using an X-rite 9600 spectrophotometer. The cool roof coating samples are then tested according to the ASTM E-903-12 test method for average total solar absorptance and average total solar reflectance using a LPSR 300 (S/N 199H) from AZ Technology, Inc. over a 200-2500 nm wavelength with absolute integrating sphere, 15°/h. The L*, contrast ratio, average total solar absorptance and average total solar reflectance are all reported in Table 3. The dry film density (grams per square meter of the coating) is determined and also reported in Table 3.

TABLE 1

| | Wt | Wt % |
|---|---|---|
| | (g) | (total) |
| COMPONENT A | | |
| Water | 145 | 11.62 |
| Dispersant (Dispex 4144, 35 wt % solids) | 7.55 | 0.67 |
| Antifreeze Agent (propylene glycol) | 4.68 | 0.42 |
| Potassium Tripolyphosphate Dispersant (KTPP | 1.41 | 0.13 |
| Dispersant) | | |
| Preservative | 2.31 | 0.21 |
| Defoamer (FOAMSTAR ST 2412) | 3.98 | 0.36 |
| Titanium Dioxide (TI-PURE R-960, d50 = 0.50 μm) | Varies | Varies |
| Mineral Filler | Varies | Varies |
| COMPONENT B | | |
| Aqueous Acrylic Emulsion Binder (ACRONAL 4400, | 478 | 42.82 |
| 55 wt % solids) | | |
| Ester Alcohol Coalescent (TEXANOL) | 5.49 | 0.49 |
| Cosolvent (Ammonia) | 2.42 | 0.22 |
| Hydroxyethyl cellulose thickener (CELLOSIZE in 15 | 3.5 | 0.31 |
| g water) | | |
| Propylene glycol (mix with hydroxyethyl cellulose | 12.3 | 1.10 |
| thickener) | | |
| Totals | Totals | 100 |

TABLE 2

| | Mineral | TiO₂ Wt | Viscosity | | | | Density |
|---|---|---|---|---|---|---|---|
| Mineral Filler | Filler Wt (g) | (g) | (KU) | | pH | | (wet, g/cm³) |
| Example 1, silica | | | | | | | |
| filler - | | | | | | | |
| d50 = 8.3 μm | | | | | | | |
| d99 = 50 μm | | | | | | | |
| Specimen 1a | 363.5 | 100.0 | 113.10 | 113.80 | 9.3 | 9.4 | 1.34 |
| Specimen 1b | 371.0 | 86.0 | 116.6 | 119.0 | 9.4 | 9.4 | 1.34 |
| Specimen 1c | 378.0 | 75.0 | 111.6 | 112.0 | 9.4 | 9.4 | 1.37 |
| Specimen 1d | 393.0 | 50.0 | 104.4 | 105.4 | 9.3 | 9.3 | 1.32 |
| Specimen 1e | 397.4 | 42.0 | 118.1 | 118.2 | 9.4 | 9.5 | 1.34 |
| Specimen 1f | 402.6 | 33.0 | 118.6 | 119.2 | 9.4 | 9.5 | 1.31 |
| Specimen 1g | 407.5 | 25.0 | 109.8 | 110.6 | 9.4 | 9.5 | 1.29 |
| Specimen 1h | 416.5 | 10.0 | 110.4 | 111.0 | n/a | n/a | 1.30 |
| Specimen 1i | 421.9 | 0.0 | 109.9 | 113.8 | 9.5 | 9.3 | 1.29 |
| Example 2, silica | | | | | | | |
| filler - | | | | | | | |
| d50 = 7.8 μm | | | | | | | |
| d99 = 12.2 μm | | | | | | | |
| Specimen 2a | 371.0 | 86.0 | 115.4 | 118.0 | 9.1 | 9.1 | 1.34 |
| Specimen 2b | 392.8 | 50.0 | 114.7 | 115.8 | 9.1 | 9.2 | 1.33 |
| Specimen 2c | 402.6 | 33.0 | 115.7 | 116.7 | 9.1 | 9.2 | 1.31 |
| Specimen 2d | 407.4 | 25.0 | 112.6 | 113.1 | 9.2 | 9.3 | 1.30 |
| Specimen 2e | 416.5 | 10.0 | 110.0 | 110.0 | n/a | n/a | 1.29 |
| Comparative | | | | | | | |
| Example, CaCO₃ - | | | | | | | |
| d50 = 11.6 μm | | | | | | | |
| d99 = 45 μm | | | | | | | |
| Comp. Ex. | 429.5 | 86.0 | 103.0 | 102.0 | 9.6 | 9.7 | 1.40 |
| Specimen a | | | | | | | |
| Comp. Ex. | 453.1 | 50.0 | 111.0 | 112.0 | 9.3 | 9.3 | 1.38 |
| Specimen b | | | | | | | |
| Comp. Ex. | 470.0 | 25.0 | 112.1 | 112.3 | 9.4 | 9.5 | 1.38 |
| Specimen c | | | | | | | |
| Comp. Ex. | 480.5 | 10.0 | 109.0 | 109.0 | — | — | 1.37 |
| Specimen d | | | | | | | |
| Comp. Ex. | 487.0 | 0.0 | 111.6 | 112.4 | 9.2 | 9.2 | 1.35 |
| Specimen e | | | | | | | |

TABLE 3

| | | | | | | | Dry |
|---|---|---|---|---|---|---|---|
| | Mineral | TiO₂ | L* | Contrast | Avg Total | Avg. Total | Film |
| | Filler | Wt | (20 | Ratio (20 | Solar | Solar | Density |
| Mineral Filler | Wt (g) | (g) | mil wet) | mil wet) | Absorbance | Reflectance | (g/m²) |
| Example 1, | | | | | | | |
| silica filler - | | | | | | | |
| d50 = 8.3 μm | | | | | | | |
| d99 = 50 μm | | | | | | | |
| Specimen 1a | 363.5 | 100.0 | 98.16 | 99.84 | 0.132 | 0.868 | 834.9 |
| Specimen 1b | 371.0 | 86.0 | 97.94 | 99.71 | 0.137 | 0.863 | 834.9 |
| Specimen 1c | 378.0 | 75.0 | 98.02 | 99.68 | 0.137 | 0.863 | 864.2 |
| Specimen 1d | 393.0 | 50.0 | 97.66 | 99.37 | 0.135 | 0.865 | 810.5 |
| Specimen 1e | 397.4 | 42.0 | 97.53 | 99.08 | 0.162 | 0.838 | 834.9 |
| Specimen 1f | 402.6 | 33.0 | 97.28 | 98.46 | 0.176 | 0.824 | 805.6 |
| Specimen 1g | 407.5 | 25.0 | 96.81 | 97.65 | 0.163 | 0.837 | 786.1 |
| Specimen 1h | 416.5 | 10.0 | 95.18 | 91.66 | 0.253 | 0.747 | 795.8 |
| Specimen 1i | 421.9 | 0.0 | N/A | 12.150 | 0.292 | 0.708 | 786.1 |
| Example 2, | | | | | | | |
| silica filler - | | | | | | | |
| d50 = 7.8 μm | | | | | | | |
| d99 = 12.2 μm | | | | | | | |
| Specimen 2a | 371.0 | 86.0 | 98.09 | 99.74 | 0.130 | 0.870 | 834.9 |
| Specimen 2b | 392.8 | 50.0 | 97.64 | 99.31 | 0.152 | 0.848 | 820.2 |
| Specimen 2c | 402.6 | 33.0 | 97.22 | 98.57 | 0.172 | 0.828 | 805.6 |
| Specimen 2d | 407.4 | 25.0 | 96.76 | 97.91 | 0.189 | 0.811 | 795.8 |
| Specimen 2e | 416.5 | 10.0 | 95.32 | 91.76 | 0.244 | 0.756 | 791.0 |
| Comparative | | | | | | | |
| Example, | | | | | | | |
| CaCO₃ - | | | | | | | |
| d50 = 11.6 μm | | | | | | | |
| d99 = 45 μm | | | | | | | |
| Comp. Ex. | 429.5 | 86.0 | 96.36 | 99.94 | 0.164 | 0.836 | 893.5 |
| Specimen a | | | | | | | |
| Comp. Ex. | 453.1 | 50.0 | 95.71 | 99.90 | 0.177 | 0.823 | 869.1 |
| Specimen b | | | | | | | |
| Comp. Ex. | 470.0 | 25.0 | 94.11 | 99.20 | 0.224 | 0.776 | 874.0 |
| Specimen c | | | | | | | |
| Comp. Ex. | 480.5 | 10.0 | 92.11 | 96.35 | 0.277 | 0.723 | 864.2 |
| Specimen d | | | | | | | |
| Comp. Ex. | 487.0 | 0.0 | 89.03 | 70.37 | 0.270 | 0.730 | 849.5 |
| Specimen e | | | | | | | |

TABLE 4

| Mineral | Particle Size (μm) | | | | | XRite Color | | | Specific |
|---|---|---|---|---|---|---|---|---|---|
| Filler | d50 | Mean | d10 | d90 | d99 | L* | a* | b* | Gravity |
| Example 1 | 8.3 | 11.2 | 1.4 | 26.7 | 50 | 98.52 | −0.1 | 0.21 | 2.34 |
| (silica filler) | | | | | | | | | |
| Example 2 | 7.8 | 12.2 | 1.4 | 30 | 45 | 97.6 | −0.16 | 0.52 | 2.34 |
| (silica filler) | | | | | | | | | |
| Comparative | 11.6 | 13.7 | 1.5 | 29.2 | 45 | 96.34 | 0.28 | 1.67 | 2.7 |
| Example | | | | | | | | | |
| (CaCO₃) | | | | | | | | | |

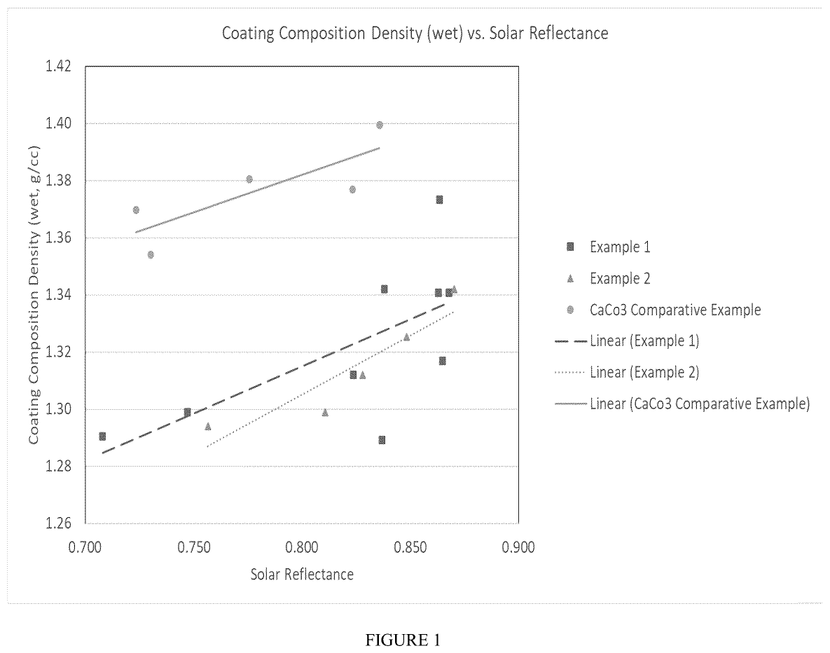

As shown in FIG. 1 the lightweight liquid coating composition of the present disclosure represented by Examples 1 and 2 have a much lower wet density (from Table 2) but provide the same or better solar reflectance (from Table 3) as compared to the comparative liquid coating composition containing the calcium carbonate as the Mineral Filler. Similarly, the dried lightweight coating of the present invention represented by Examples 1 and 2 have a much lower dry film density (from Table 3) but provide the same or better solar reflectance (from Table 3) as compared to the comparative liquid coating composition containing the calcium carbonate as the Mineral Filler.

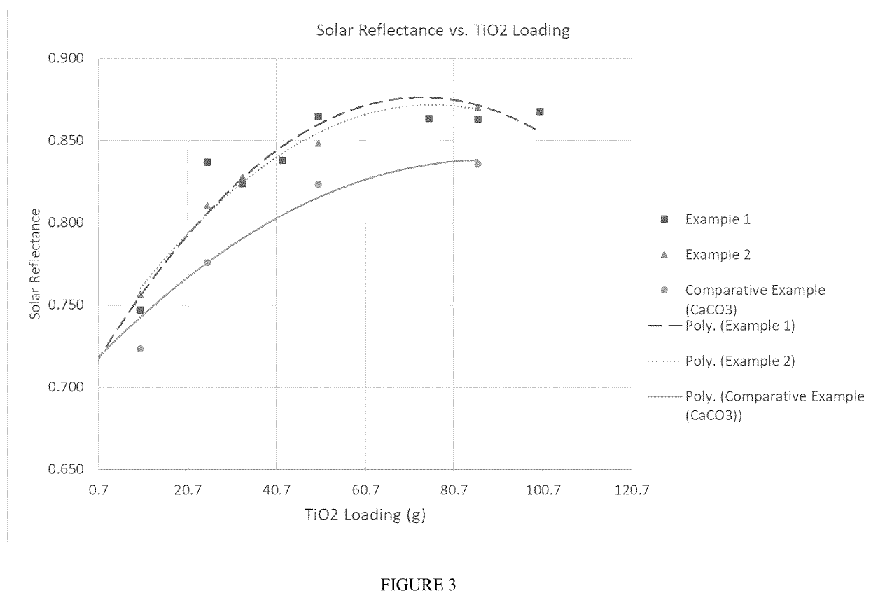

FIG. 3 shows the average total solar reflectance of the invention represented by Examples 1 and 2 versus the titanium dioxide loading (Table 3). This figure shows that the lightweight coating using the silica filler in accordance with the present disclosure provides a higher solar reflectance and/or lower solar absorbance (given that solar absorbance=1−solar reflectance) than that of the comparative calcium carbonate filler.

Unless otherwise indicated herein, the values, properties, and parameters of the coating compositions, components of the coating compositions (e.g., silica filler), coatings, etc. of the present disclosure are determined in accordance with the equipment and methods described in the Examples.

The terminology as set forth herein is for description of the aspects only and should not be construed as limiting the disclosure as a whole. All references to singular characteristics or features of the present disclosure shall include the corresponding plural characteristic or feature, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” or “and/or” is employed (e.g., A or B, or A and/or B) it is intended to mean “A or B or both.” When the applicants intend to indicate “only A or B but not both” then the term “only A or B but not both” will be employed. Thus, use of the term “or” herein is the inclusive, and not the exclusive use.

The exterior composite boards of the present disclosure can comprise, consist of, or consist essentially of the essential elements of the disclosure as described herein, as well as any additional or optional element described herein or which is otherwise useful in the boards.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The term “about” as used herein means approximately, in the region of, roughly, or around. When the term “about” is used in conjunction with a numerical range, it modifies that range by extending the boundaries above and below the numerical values set forth.

Any combination of method or process steps as used herein may be performed in any order, unless otherwise specified or clearly implied to the contrary by the context in which the referenced combination is made.

What is claimed is:

1. A lightweight cool roof coating composition comprising:
an aqueous polymer emulsion binder; and
a pigment-filler component comprising:
a reflective pigment, and
a silica filler comprising cristobalite, tridymite, and optionally quartz, the silica filler comprising at least 50 wt % cristobalite based on the weight of the silica filler,
wherein the lightweight cool roof coating composition has a density (wet) of less than or equal to 1.38 g/cm³ at a Pigment Volume Concentration (PVC) of 42%.

2. The lightweight cool roof coating composition of claim 1, wherein the reflective pigment comprises titanium dioxide.

3. The lightweight cool roof coating composition of claim 2, wherein the pigment-filler component consists of titanium dioxide and the silica filler.

4. The lightweight cool roof coating composition of claim 1, wherein the silica filler comprises:
50-99 wt % cristobalite,
1-30 wt % tridymite, and
0-50 wt % quartz.

5. The lightweight cool roof coating composition of claim 1, wherein the silica filler has a d50 particle size of 2-12 μm.

6. The lightweight cool roof coating composition of claim 5, wherein the silica filler has:
L* of 97-99,
a* less than 0, and
b* of 0-0.75.

7. The lightweight cool roof coating composition of claim 1, wherein the silica filler has a specific gravity of 2.3-2.4.

8. The lightweight cool roof coating composition of claim 1, wherein the lightweight cool roof coating composition has a density (wet) of 1.25-1.38 g/cm³ at a Pigment Volume Concentration (PVC) of 42%.

9. The lightweight cool roof coating composition of claim 1, wherein when applied at 20 mils (wet) thickness on a substrate, the lightweight cool roof coating composition forms a lightweight cool roof coating having an L* of 95-99 and an average solar reflectance of at least 0.75.

10. The lightweight cool roof coating composition of claim 9, wherein the lightweight cool roof coating has an average total solar absorbance of less than 0.26.

11. The lightweight cool roof coating composition of claim 1, wherein the lightweight cool roof coating has a surface density (dry) of 780-865 g/m².

12. The lightweight cool roof coating composition of claim 1, wherein the aqueous polymer emulsion binder comprises an acrylic emulsion binder, a silicone emulsion binder, a polyurethane emulsion binder, or combinations thereof.

13. The lightweight cool roof coating composition of claim 1 comprising 35-50% PVC.

14. The lightweight cool roof coating composition of claim 1 comprising from 25-40 wt % silica filler based on the total weight of the lightweight cool roof coating composition.

15. A coated substrate comprising a structural substrate and the lightweight cool roof coating composition of claim 1 disposed thereon.

16. The coated substrate of claim 15, wherein the structural substrate is a roof.

17. The coated substrate of claim 16, wherein the roof is a low-slope or flat roof.

18. A method of applying a cool roof to a structure comprising applying the lightweight cool roof coating composition of claim 1 to a roof of a structure.

19. A method of making the lightweight cool roof coating composition of claim 1 comprising:
combining the reflective pigment and silica filler with water and dispersing to form a mixture, and
adding the aqueous polymer emulsion binder to the mixture and mixing to form the lightweight cool roof coating composition.

20. A lightweight reflective coating composition comprising:
a binder system comprising an aqueous acrylic emulsion binder, a (meth)acrylate-based binder system, a solvent-based resin binder system, a low-VOC solvent-based binder system, a two-component binder system, or a thermoplastic binder system; and
a pigment-filler component comprising:
a reflective pigment, and
a silica filler comprising cristobalite, tridymite, and optionally quartz, the silica filler comprising at least 50 wt % cristobalite based on the weight of the silica filler, wherein the silica filler has:
L* of 97-99,
a* less than 0, and
b* of 0-0.75.

21. The lightweight reflective coating composition of claim 20, wherein the silica filler comprises:
50-99 wt % cristobalite,
1-30 wt % tridymite, and
0-50 wt % quartz.

22. A coated substrate comprising a substrate and the lightweight reflective coating composition of claim 21 disposed thereon.

23. The coated substrate of claim 22, wherein the substrate is cement or asphalt pavement.
